(19) United States
(12) Patent Application Publication
(10) Pub. No.: US 2024/0310479 A1
(43) Pub. Date: Sep. 19, 2024

(54) METHOD FOR OPERATING AN ULTRA WIDE-BAND DEVICE, ULTRA WIDE-BAND DEVICE, AND VEHICLE COMPRISING AN ULTRA WIDE-BAND DEVICE

(71) Applicant: Continental Automotive Technologies GmbH

(72) Inventors: Lars Weisgerber, Regensburg (DE); Mario Schuehler, Effeltrich (DE)

(73) Assignee: Continental Automotive Technologies GmbH, Hannover (DE)

(21) Appl. No.: 18/280,110

(22) PCT Filed: Feb. 23, 2022
(86) PCT No.: PCT/DE2022/200027

§ 371 Date: Sep. 1, 2023

(30) Foreign Application Priority Data
Mar. 2, 2021 (DE) 10 2021 201 968.4

(51) Int. Cl. G01S 7/288; G01S 13/02; G01S 13/58; H04L 25/02

(52) U.S. Cl. CPC G01S 7/2886; G01S 7/2883; G01S 13/0209; G01S 13/582; H04L 25/0212

(57) ABSTRACT

An ultra-wideband sensor transmits impulse radio signals at different times and generates respective channel impulse responses that describe a respective reflected signal as a function of a path delay. The channel impulse responses are used to generate a time-variant channel impulse response in which the channel impulse responses are arranged according to the times of transmission of the respective associated impulse radio signals. At least one respective local maximum of the scatter function quantity, characterized by a respective Doppler frequency and a respective path delay, is detected in scatter functions of respective time windows. A predetermined selection method is used to select at least one local maximum as the respective observation maximum to be tracked for motion detection. A signal characteristic of the channel impulse response is generated for the respective observation maximum to be tracked and a predetermined motion detection method detects at least one predetermined movement.

The invention relates to a method for operating an ultra-wideband device, an ultra-wideband device and a vehicle that comprises an ultra-wideband device.

The automotive sector is currently undergoing major changes towards electromobility and connectivity. In the future, vehicles and users will be constantly connected to one another, vehicles will intuitively know what the user needs, and the vehicle will be able to respond and correspondingly adapt to the user's needs and the changing surroundings and conditions. In the near future, vehicles will be constantly networked to one another and will continually monitor their surroundings.

Observing and capturing the surroundings of the vehicle and a state of the vehicle itself will be a complex operation that will be required prior to an autonomous analysis and reaction process. In the future, the vehicle will decide what information is relevant and important to the driver and will provide this information to the driver for assistance. The vehicle will also undertake complex tasks to relieve and protect the driver.

In order to provide intelligent services such as these, a large number of problems need to be solved. The handling and processing of the large volumes of data and the information they provide is a complex topic. The first step in facilitating the intelligent services is the provision of meaningful data by reliable sensor units of the vehicle. This point is one of the biggest challenges in the entire service chain. It is necessary to clarify which sensor unit is useful and necessary for providing a function, and whether the sensor units are fully integrated and cost-effective. A sensor unit may perform different tasks. Sensor units can merge in order to set up necessary redundancy and/or to reduce unnecessary redundancy. In order to be able to use a sensor unit for different tasks, however, specific data processing routines are required.

A part of the vehicle sensor system is provided to detect movements in the vehicle interior or in the surroundings of the vehicle. According to the current prior art, the sensor units used for this are capacitive, radar-, ultrasound-, laser- or camera-based. The sensor system for detecting movement in the vehicle interior is provided, for example, to detect a person or a state of a person in the vehicle interior. Motion detection is also used in systems intended to monitor the fatigue or health of a driver. According to the current prior art, complex camera-based systems that involve the use of image recognition methods to observe the vehicle interior are used for said systems for monitoring the vehicle interior.

Another area of application for motion detection sensors are systems for automatically unlocking the trunk and/or opening the trunk. These detect a specific movement pattern, such as a kick from a person, in order to unlock and/or open the trunk when predetermined conditions exist. Multiple problems arise when using the typical capacitive sensors, radar-based sensors or ultrasonic sensors. On the one hand, a specific motion detection method is required in order to be able to identify the footstep in the sensor data. A second problem is the occurrence of erroneous footstep detection, which can occur for example if animals such as cats or dogs are situated behind or under the vehicle. A movement pattern of this animal can be mistakenly identified as a footstep and lead to the trunk being opened. Another problem arises if a sensor is covered by dirt or snow. In this case, motion detection is limited or not possible. This problem occurs in particular with camera-based and capacitive sensors.

An alternative to providing additional sensors for motion detection is to use sensors that are already present. The ultra-wideband sensor system of a vehicle is particularly suitable for this. The recent integration of ultra-wideband location technologies in smart access and relay attack defense services will provide a new type of technology for the automotive sector that, besides precise determination of a signal propagation time between the sensors and a key, additionally provides a simple radar functionality. The ultra-wideband sensor system covers a bandwidth of at least 500 MHz, for example.

Ultra-wideband systems are primarily designed to determine the range and position of the user's ultra-wideband digital key. For this purpose, the vehicle is equipped with multiple wideband communication transceivers (responders) in different positions, for example in the interior or outside, which locate the digital key by communicating with at least one wideband counterpart transceiver (initiator) in the digital key in order to use the signal propagation time to determine the distance between the initiator and the responders. By determining the distances between the initiator and the individual responders, the position of the digital key can be computed using trilateration.

The channel impulse response is used in the known key locating methods to determine the signal propagation time on the two sides (initiator, responder). This means that the basis for a passive evaluation of a spatial channel impulse response already exists. In this case, an impulse transmitted by a sensor can be correlated with the reflected impulse detected by the sensor, without an active counterpart being necessary. The continuous repetition of a transmission-reception correlation process allows spatial changes such as predetermined movement patterns, for example a kick or a respiratory movement by a person, to be detected.

Specific approaches to motion detection by means of ultra-wideband sensors are described in the publications below.

The publication YIN, Wenfeng, et al. Hear: Approach for heartbeat monitoring with body movement compensation by ir-uwb radar. Sensors, 2018, 18th year, No 9, p. 3077, describes an approach for detecting a heartbeat. The approach provides for detecting the vital signals by mapping the maximum echo amplitudes to the path delay.

KIM, Seong-Hoon; GEEM, Zong Woo; HAN, Gi-Tae. A Novel Human Respiration Pattern Recognition Using Signals of Ultra-Wideband Radar Sensor. Sensors, 2019, 19th year, No 15, p. 3340, describes an evaluation of respiration signal data captured by means of ultra-wideband radar. A neural network is used to recognize breathing patterns in the respiration signal data.

AHMED, Shahzad; CHO, Sung Ho. Hand Gesture Recognition Using an IR-UWB Radar with an Inception Module-Based Classifier. Sensors, 2020, 20th year, No 2, p. 564, describes detection of gestures by means of UWB radar.

KOO, Yun Seo, et al. UWB MicroDoppler Radar for human Gait analysis, tracking more than one person, and vital sign detection of moving persons. In: 2013 IEEE MTT-S International Microwave Symposium Digest (MTT). IEEE, 2013. pages 1-4, describes the use of a UWB micro-doppler radar to capture vital data.

LI, Xin, et al. A novel through-wall respiration detection algorithm using UWB radar. In: 2013 35th Annual International Conference of the IEEE Engineering in Medicine and Biology Society (EMBC). IEEE, 2013. pp. 1013-1016, discloses a method for identifying a respiratory movement through walls by means of a UWB radar.

In the case of the latter methods, the problem arises for practical use in vehicles that ultra-wideband sensors installed in vehicles generally do not have the spatial resolution required to carry out these methods. This is because, for the Doppler spectrum analysis used in these documents, it is necessary to know an exact distance of the object that is intended to be examined using the Doppler spectrum.

The problem is that the spatial or range resolution of the usual sensors is not sufficient to detect certain, smaller changes in distances between an object and a sensor, such as occur for example when the chest moves during respiration. The same problem also exists for the identification of a person's quick footstep or kick.

It is an object of the invention to provide a method that facilitates motion detection for small movements without the availability of precise distance information by means of an ultra-wideband sensor system.

The basic idea of the invention is that a distance from a moving object is determined by evaluating a time-variant Doppler spectrum, in order to facilitate a signal analysis for this distance in order to detect the movement.

The invention relates to a method for operating an ultra-wideband device. There is provision for an ultra-wideband sensor of the ultra-wideband device to transmit impulse radio signals at different times and to generate respective channel impulse responses (h(τ)) that describe a respective reflected echo signal as a function of a path delay τ. The path delay τ describes the time between the transmission of an impulse radio signal and the reception of the reflected echo signal by the ultra-wideband sensor. The path delay τ is also referred to as fast time or echo time. The ultra-wideband device can be arranged in a vehicle, for example, and can comprise one or more of the ultra-wideband sensors. The respective ultra-wideband sensors can be configured to transmit the impulse radio signals and/or to receive the echo signals of the impulse radio signals. The transmitted impulse radio signals can be transmitted at different times at constant or varying intervals of time from one another along a time t. The time t describes the time referred to as slow time, which indicates the transmission time of the respective impulse radio signal. The impulse radio signals can be reflected by static and moving objects in the surroundings. Individual reflections of an impulse radio signal can occur from various objects in the surroundings. Depending on the distance between the respective object and the ultra-wideband sensor, the echo signal is detected by the ultra-wideband sensor after a respective path delay τ. To describe the response of the system to an impulse radio signal sent at a known time in the time t, the ultra-wideband device can generate the channel impulse response h(τ), which can describe a parameter such as an intensity or a phase of the received echo signal over the path delay τ. Such a channel impulse response h(τ) is produced for each impulse radio signal that was transmitted at a respective time in the time t. The response of the system to the impulse radio signal can therefore be described as a function of the path delay τ, which correlates with a distance of a reflecting object, and as a function of a time t. For this purpose, the channel impulse responses h(τ) are combined to form a time-variant channel impulse response h(t, τ). The channel impulse responses h(τ) are thus used to generate a time-variant channel impulse response h(t, τ) in which the channel impulse responses h(τ) are described as a function of the time t. The time-variant channel impulse response h(t, τ) can be a matrix, for example, the rows of which can have an associated time t and the columns of which can have the associated path delay τ.

Predetermined time windows for the time t in the time-variant channel impulse response h(t, τ) are transformed to produce respective scatter functions hs(v, τ) of the Doppler frequency v. The transformation can be, for example, a discrete cosine transformation, a Laplace transformation, a Walsh transformation, one of the Fourier transformations or a variant of the discrete Fourier transformation.

This is necessary because the time-dependent components of the time-variant channel impulse response h(t, τ), which describe changes in the system and are caused by movements, are relevant to the detection of movements. Static components, on the other hand, are not relevant. In order to be able to detect these changes, the time-variant channel impulse response h(t, τ) is transformed from a time domain t to the frequency domain v for the predetermined time windows, as a result of which the Doppler shifts and Doppler frequencies caused by movements can be ascertained. If a transformation were performed over a longer time period of the time-variant channel impulse response h(t, τ) rather than over individual time windows, there would be a resultant superimposition of multiple Doppler frequencies v, meaning that individual movements might sometimes not be able to be identified. For this reason, multiple scatter functions hs(v, τ) are generated for the respective predetermined time windows.

A movement leads to a Doppler shift in the frequency, which, depending on the speed of the movement, has a respective Doppler frequency v and leads to a local maximum in the respective scatter function hs(v, τ). The local maximum is characterized by the respective Doppler frequency v and by the respective path delay τ, which depends on the distance of the moving object from the ultra-wideband sensor.

At least one respective local maximum P of the scatter function quantity, characterized by a respective Doppler frequency vP and a respective ascertained path delay TP=P τ0, is detected in the scatter functions hs(v, τ) of the respective time windows. Here, P denotes an index of the path delay and TO denotes a sampling period of the channel impulse response with respect to the path delay τ. In order to be able to detect a movement and track its course, it is necessary to use a selection method that selects at least one local maximum according to predetermined specifications as the respective observation maximum P to be tracked for motion detection.

A signal characteristic φ(t) for the channel impulse response h(t, τP) is generated for the respective observation maximum P to be tracked, using the at least one ascertained path delay τP=P τ0. The signal characteristic φ(t) can in particular be a phase, frequency or amplitude characteristic for the path delay τP. A predetermined motion detection method detects at least one predetermined movement of the observation maximum P to be tracked in the signal characteristic φ(t) of the channel impulse response h(t, τP).

Although the spatial resolution of the ultra-wideband sensor technology used is not sufficient for detecting small movements, such as a movement of a chest during respiration, it is possible to detect these small movements from a change in the phase between successive channel impulse responses h(τ), for example. This situation is the starting point for the method. However, the problem here is that the distance between the ultra-wideband sensor and the moving object may be unknown. For example, depending on a person's height, a distance of the person's hand or chest from the ultra-wideband sensor can vary, meaning that a predetermined distance cannot be used for detecting movements of the hand or chest. The objects or people to be monitored may, for example, be on a seat on the right or left side of the vehicle, or may be in another position. This means that, for example, two distances, or two path delays τP, can be considered for monitoring the object or person. However, the distance between the moving object and the ultra-wideband sensor must be known in order to be able to identify the phase change to be observed. It is therefore necessary to find a solution that facilitates distance determination between the moving object and the ultra-wideband sensor.

An evaluation of a single channel impulse response h(τ) does not lead to a movement being detected. A movement that leads to a change of location for the object could be detected using the known interval of time between successive path delays τ in the channel impulse response. If the change of location is below the spatial resolution of the ultra-wideband sensor, this is not possible. However, a variation in the phase between multiple successive channel impulse responses h(τ) can be evaluated.

The time-variant channel impulse response h(t, τ) describes the response of the system as a function of a transmission time t of the impulse radio signal, the temporal variable t, which relates to the transmission times of the impulse radio signals, being denoted by t and the path delay, which describes the path delay between the transmission of an impulse radio signal and the reception of an echo signal, being denoted by τ. It is assumed in the method that a movement in a monitored environment causes a time-variant channel impulse response h(t, τ) of the system. A change in the time-variant channel impulse response h(t, τ) over the time t is therefore useful for detecting movements. In order to be able to identify the change in successive channel impulse responses h(τ), the transformation from t to v is applied to the time-variant channel impulse response h(t, τ), resulting in the scatter function hs(v, τ). The scatter function hs(v, τ) describes the response of the system as a function of the Doppler frequency v and the path delay τ. The scatter function hs(v, τ) thus shows the Doppler spectrum for a respective path delay τ. A frequency shift caused by the Doppler effect during a movement can be identified in the scatter function as a local maximum P that occurs for a specific path delay τP, which depends on the distance between the movement and the sensor. The respective distance from the ultra-wideband sensor at which the movement occurs can be determined using the path delay τ.

The disadvantage of representing the scatter function hs(v, τ) over a longer time period is that it may not be possible to identify individual local maxima P and thus the associated movements, because a continuous Doppler spectrum results when a longer time period is taken into account. For example, a respiratory movement or a similar movement comprises a large number of acceleration, deceleration and rest phases. In order to be able to detect individual movements, it is necessary to form the scatter function hs(v, τ) for multiple shorter, predetermined periods of time, as a result of which the time-variant scatter function hs(v, τ) is formed.

For this purpose, the predetermined periods of time are selected as time windows. Respective scatter functions hs(v, τ) are produced for the individual periods of time. Respective local maxima P characterized by the respective path delay τP and the respective Doppler frequency vP can be detected in these scatter functions hs(v, τ), which relate to a relatively short time period, in contrast to the scatter function hs(v, τ), which extends over a longer time period. When a position of a local maximum P is tracked over multiple scatter functions hs(v, τ), it is possible for example to detect that the Doppler frequency vP of the maximum P in the scatter functions hs(v, τ) varies over the time t.

In the case of respiration, the variation is related to a person's respiratory movement, the rate of which varies over a respiratory period. If the movements are relatively small in relation to the distance of the object, below the resolving power of the ultra-wideband sensor, the maximum P in the scatter functions hs(v, τ) always appears for an identical path delay τP. By applying the time-variant scatter function hs(v, τ), a maximum P can thus be used to determine a movement and the associated path delay τP of the maximum P.

Ideally, each of the time-variant scatter functions hs(v, τ) shows a respective maximum P for the same path delay τP. Under real conditions, different ascertained path delays τP can be obtained for a maximum P in the individual time-variant scatter functions hs(v, τ). In this case, either the ascertained path delay τP that is detected most frequently for the local maximum P is selected, this being able to be the case for example with movements of small magnitude, or all ascertained path delays τP for the local maximum P can be taken into account, which is required in the case of larger movements, for example. This step determines the ascertained path delay τP or the ascertained path delays τP for which the movement occurs. The ascertained path delay τP or the ascertained path delays τP are used to evaluate the movement further and correlate with the distance between the moving object and the ultra-wideband sensor.

The required distance of the movement, or the required distances of the movement, are thus known for the further analysis of the movement. The signal characteristic φ(t) of the at least one local maximum of the path delay τP can thus be considered. In this instance, the phase can be monitored, for example. This occurs because when objects are moving toward the ultra-wideband sensor in the radial direction, the distance between the object and the ultra-wideband sensor changes for each channel impulse response. Due to the different distances, the reflected signals have different phase angles. This allows a movement to be detected even if the change of location of the object during the movement is below the spatial resolution of the ultra-wideband sensor.

For the at least one observation maximum P that is to be tracked, the signal characteristic φ(t) over the time t is generated from the channel impulse response h(t, τP). This involves producing the signal characteristic φ(t) for the at least one ascertained path delay τP for which the observation maximum P was detected in the scatter functions hs(v, τ). In the case of movements that extend over a radial distance of such magnitude that the observation maximum in the individual scatter functions hs(v, τ) has different path delays τP, it may be necessary to assemble the signal characteristic ϕ(t) for the at least one observation maximum from signal characteristics φ(t) for different ascertained path delays τP. The signal characteristic φ(t) can be evaluated by means of a predetermined motion detection method in order to be able to detect predetermined movements.

One development of the invention provides for a periodic movement to be detected as the predetermined movement by the predetermined motion detection method. In other words, the predetermined movement detected in the signal characteristic φ(t) of the time-variant channel impulse response h(t, τ) by the predetermined motion detection method is a periodic movement. Periodic means that the movement can be detected as a result of a periodic response in the signal characteristic φ(t). There can be provision, for example, for the predetermined movement that is to be detected to describe a respiration or a heartbeat. During the respiration and the heartbeat, periodic movements of the chest occur, which can be detected in the signal characteristic φ(t). In order to be able to detect the predetermined movement, there can be provision for the signal characteristic φ(t) of the channel impulse response to be transformed from the time domain to the frequency domain. This allows predetermined movements with predetermined frequencies to be detected in the frequency spectrum of the phase on the basis of maxima that occur. This can be, for example, a fundamental oscillation of a respiration, which is at 0.39 Hz, a harmonic oscillation of the respiration, which is at 0.78 Hz, or a second harmonic oscillation, which is at 1.17 Hz. A frequency of 0.98 Hz can also be predefined in order to detect a heartbeat. As a result, it may be possible to detect predetermined movements by examining the frequency spectrum for the occurrence of predetermined frequencies. There can be provision for a predetermined minimum amplitude to have to be exceeded in order to detect the predetermined movement.

One development of the invention provides for a non-periodic movement to be detected as the predetermined movement by the motion detection method. In other words, the predetermined movement is a non-periodic movement. This can be a one-off movement of a hand or a leg, for example. A non-periodic movement can be detected in the signal characteristic φ(t), for example by comparing the detected signal characteristic φ(t) with a predefined signal characteristic φ(t). There can be provision in this instance for the detected signal characteristic φ(t) to be compared with one or more predefined signal characteristics φ(t) by means of a similarity function. If a predetermined similarity threshold value dc is exceeded by a similarity value d(t) calculated by the similarity function, or another predetermined criterion is met, the predetermined movement can be detected in the signal characteristic φ(t).

One development of the invention provides for the channel impulse responses to be filtered by a DC component filter. In other words, a filter is applied to the individual channel impulse responses that minimizes DC components in the channel impulse responses. This results in the advantage that an average component occurring in all channel impulse responses in relation to the Doppler spectrum is minimized. For example, the component that occurs in the scatter function hs(v, τ) at a Doppler frequency of 0 Hz is reduced by the DC component filter. This results in the advantage that static components that are not suitable for motion detection are filtered out.

One development of the invention provides for a Doppler low-pass filter to be applied to the Doppler frequency domain. This results in the advantage that high frequencies that do not belong to a movement that is to be detected are filtered out.

One development of the invention provides for the detection of the predetermined movement to result in a predetermined control signal being provided on an interface of the ultra-wideband device. In other words, the ultra-wideband device transmits the predetermined control signal as soon as the predetermined movement is detected. By way of example, there can be provision for the predetermined control signal to be output on an interface for a vehicle network based on the CAN, Lin or Ethernet standard in order to initiate a predetermined action, such as opening a trunk or outputting an alarm signal.

One development of the invention provides for a low-pass filter to be applied to the frequency domain of the signal characteristic ϕ(t). This results in the advantage that low frequencies that do not belong to a periodic movement are filtered out.

One development of the invention provides that before the motion detection method is carried out, a temporal sampling rate of the signal characteristic φ(t) is reduced by a decimator. This results in the advantage that a volume of data of the signal characteristic φ(t) can be reduced. However, the reduction requires the sampling rate to be at least sufficient to detect the Doppler frequency shift.

The invention also includes developments of the ultra-wideband device according to the invention and of the vehicle according to the invention that have features such as have already been described in connection with the developments of the method according to the invention. For this reason, the corresponding developments of the ultra-wideband device according to the invention and of the vehicle according to the invention are not described again here.

The invention also encompasses the combinations of the features of the described embodiments.

An exemplary embodiment of the invention is described below, in which regard:

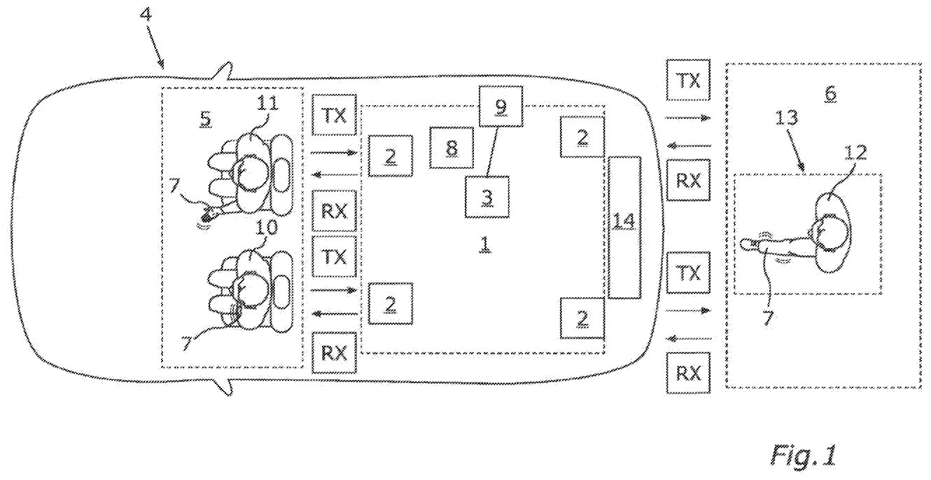

FIG. 1 shows a vehicle comprising an ultra-wideband device;

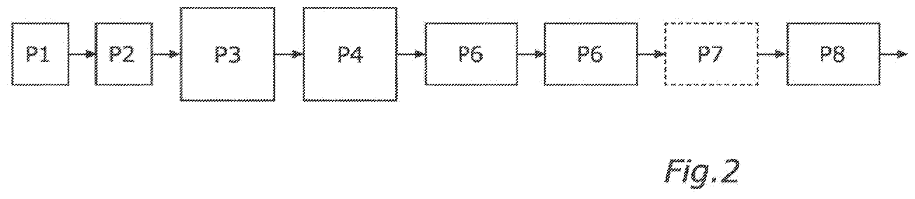

FIG. 2 shows a sequence of a method for operating an ultra-wideband device;

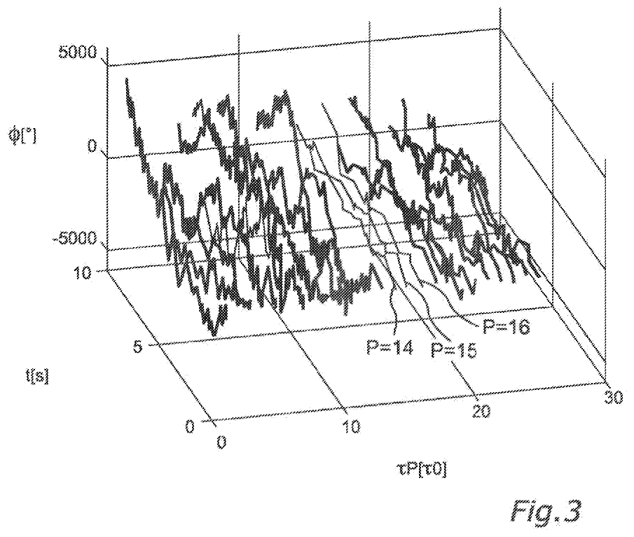

FIG. 3 shows signal characteristics as a function of t and T for a periodic movement;

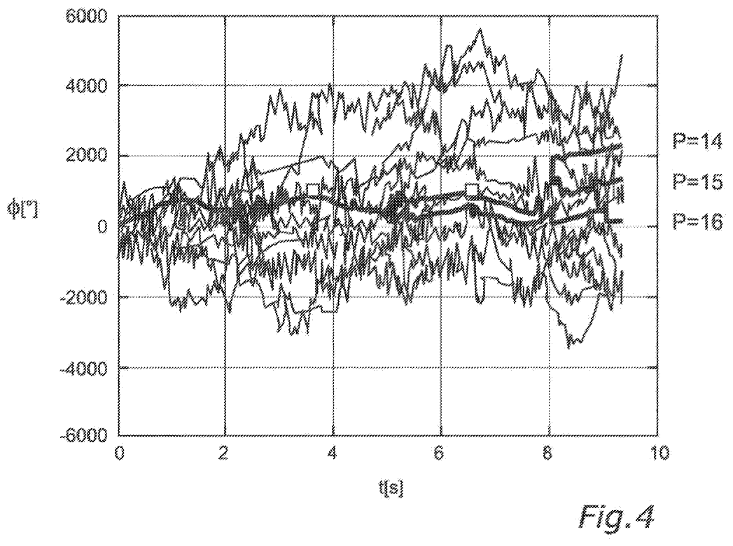

FIG. 4 shows signal characteristics as a function of t and T for a periodic movement;

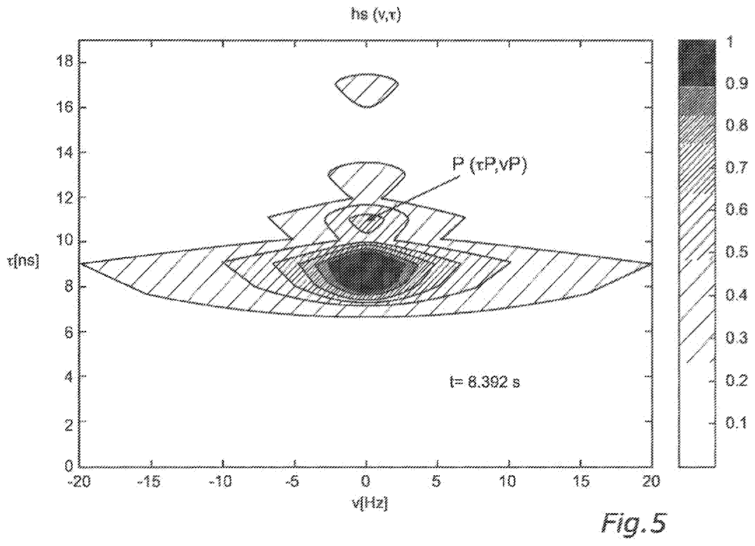

FIG. 5 shows a scatter function for a time-variant channel impulse response of a periodic movement;

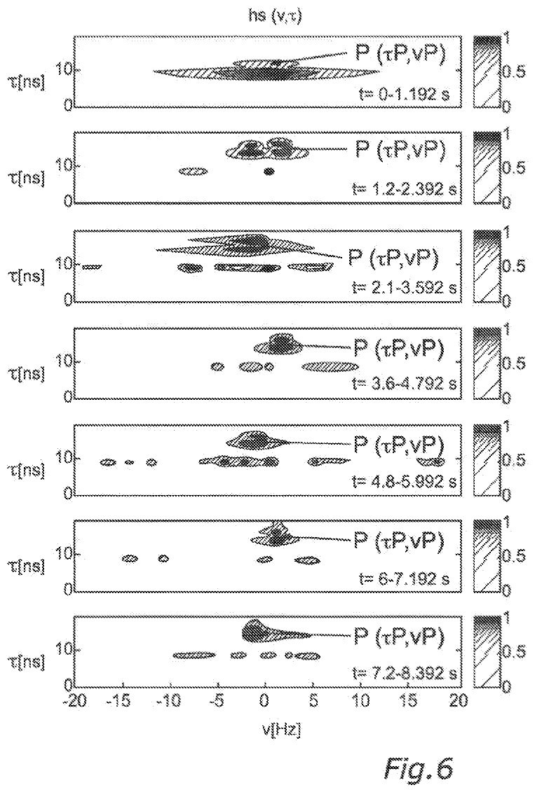

FIG. 6 shows time-resolved scatter functions for a time-variant channel impulse response of a periodic movement;

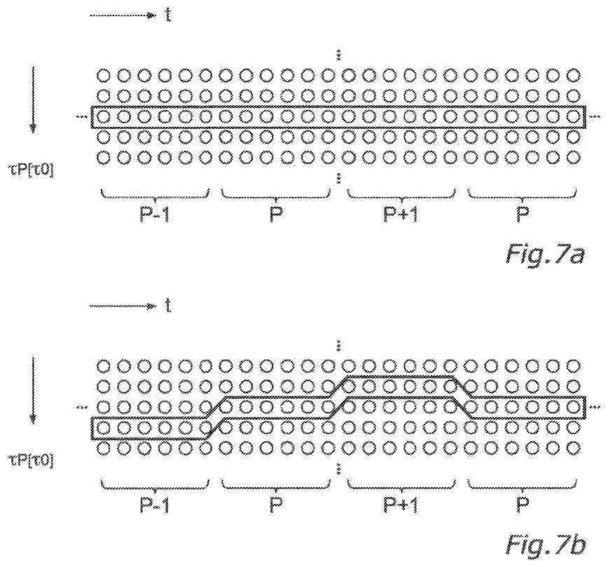

FIG. 7a shows a selection of the maxima of the time-resolved scatter function for the time-variant channel impulse response of a movement;

FIG. 7b shows a selection of the maxima of the time-resolved scatter function for the time-variant channel impulse response of a movement;

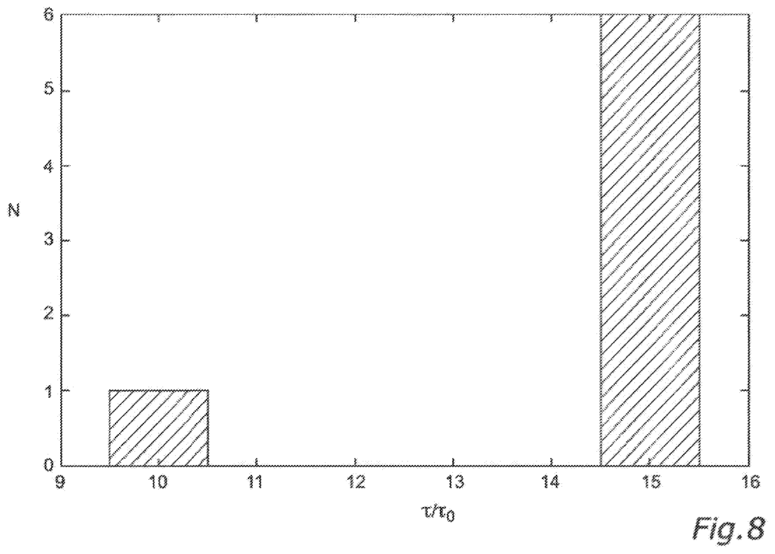

FIG. 8 shows a histogram of the taps with the most intense Doppler shifts;

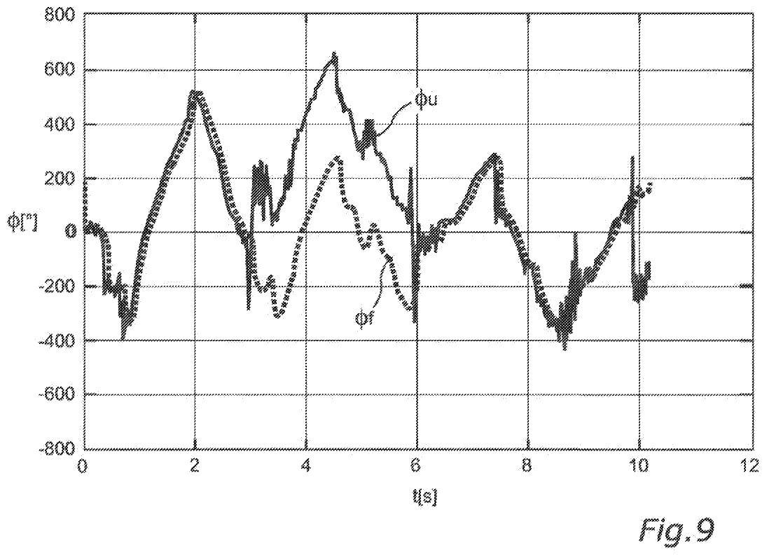

FIG. 9 shows a signal characteristic φ(t) for a tap of a periodic movement;

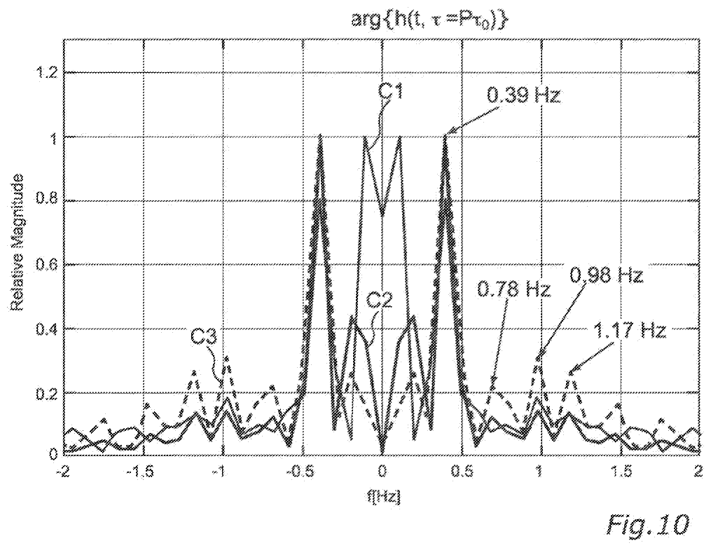

FIG. 10 shows a frequency spectrum of a signal characteristic φ(t) for a tap of a periodic movement;

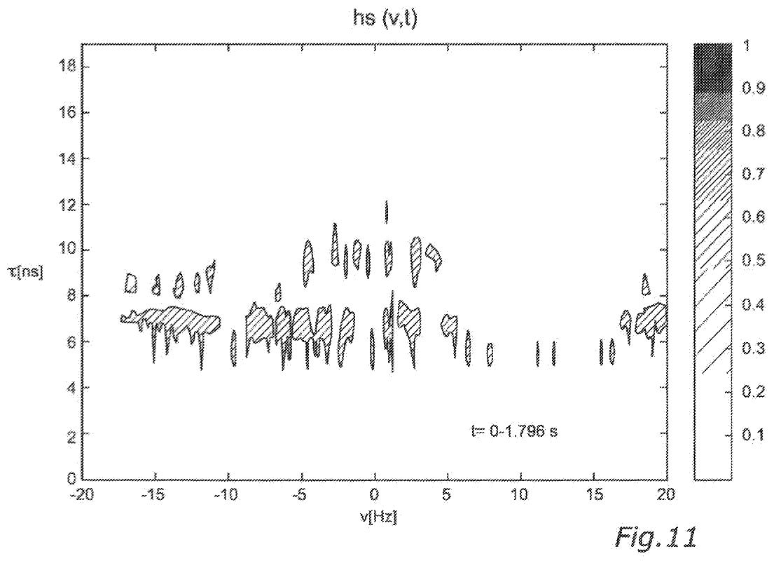

FIG. 11 shows a scatter function for a time-variant channel impulse response of a non-periodic movement;

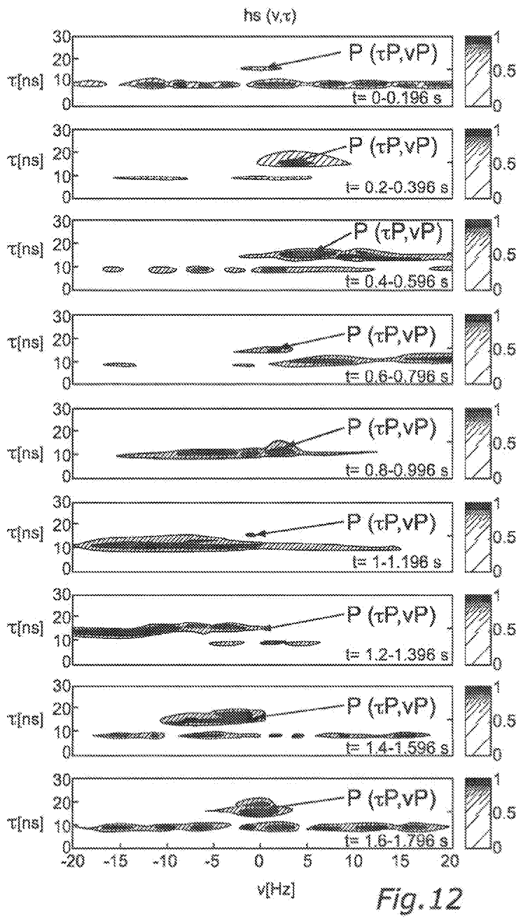

FIG. 12 shows a time-resolved scatter function for a non-periodic movement;

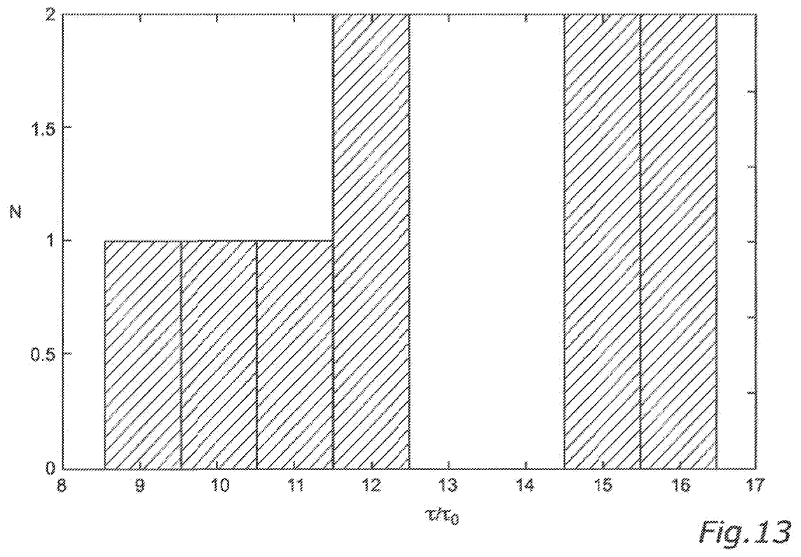

FIG. 13 shows a histogram of the path delays τ with the most intense Doppler shifts;

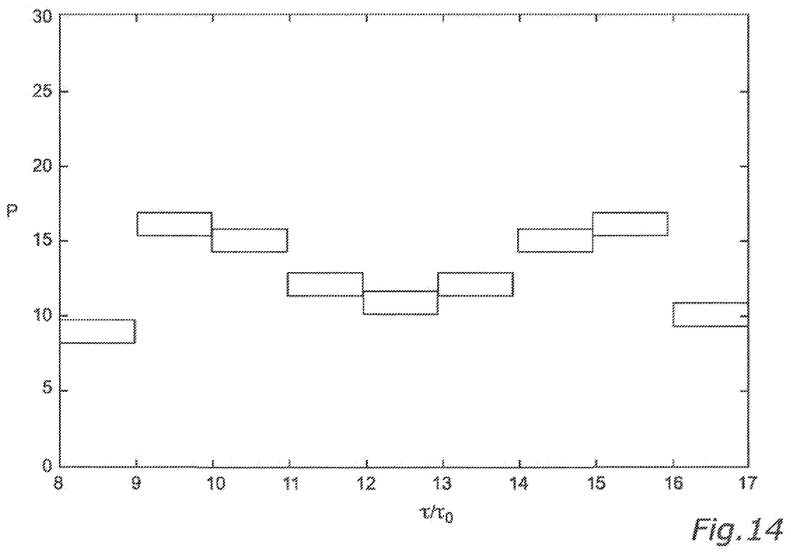

FIG. 14 shows a mask of a time-variant channel impulse response of a non-periodic movement;

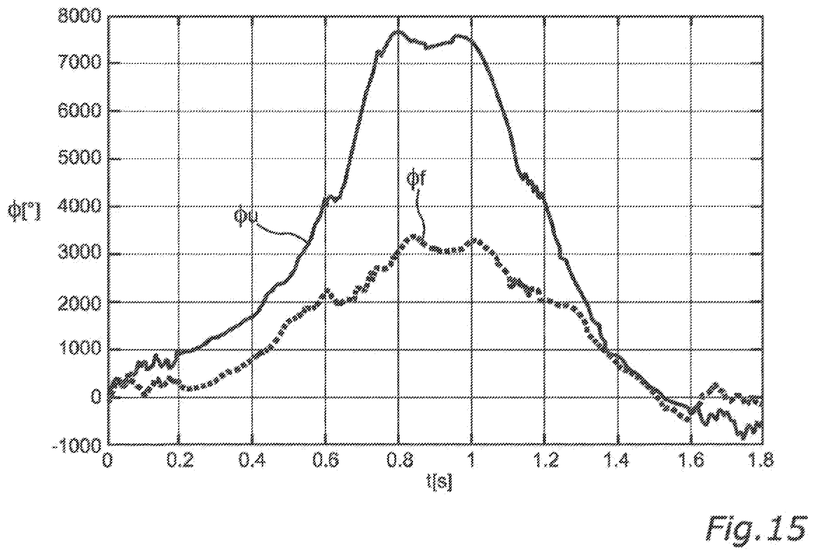

FIG. 15 shows a signal characteristic φ(t) for the time-variant channel impulse response of a non-periodic movement;

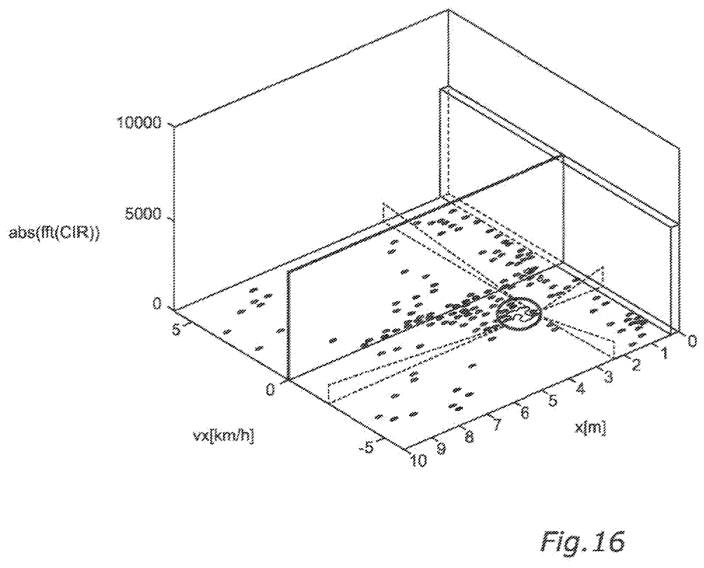

FIG. 16 shows a motion profile for a detected person;

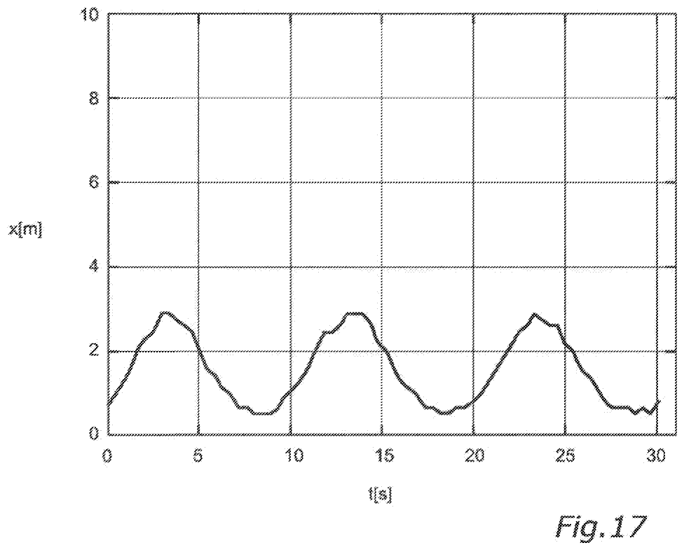

FIG. 17 shows a distance profile for a moving person.

The exemplary embodiment explained below is a preferred embodiment of the invention. In the exemplary embodiment, the described components of the embodiment each represent individual features of the invention that should be considered independently of one another and that each also develop the invention independently of one another and can therefore also be considered to be part of the invention individually or in a combination other than that shown. Furthermore, the embodiment described can also be supplemented by further features of the invention that have already been described.

In the figures, elements with the same function are each provided with the same reference signs.

FIG. 1 shows an ultra-wideband device 1, which can comprise ultra-wideband sensors 2 and a control unit 3. The ultra-wideband device 1 shown is arranged in a vehicle 4 in order to monitor an interior 5 or surroundings 6 of the vehicle 4 to provide predetermined functions. The ultra-wideband device 1 can be provided to detect movements in the interior 5 and/or the external surroundings 6 of the vehicle 4. For this purpose, some of the ultra-wideband sensors 2 can be arranged in the interior 5 of the vehicle 4, for example. At least one of the ultra-wideband sensors 2 can be arranged on a body of the vehicle 4 in order to monitor the external surroundings 6 of the vehicle 4. The ultra-wideband device 1 can be provided for the purpose of transmitting impulse radio signals TX and receiving associated echo signals RX in order to detect the movements in the interior 5 or the surroundings 6. There can be provision for the detection of predetermined movements 7 by the control device 3 to result in a control signal 8 being provided on an interface 9 for the vehicle 4 in order to enable predetermined functions or to initiate predetermined actions. There can be provision for the ultra-wideband device 1 to be provided to monitor the interior 5 of the vehicle 4 in order to monitor, for example, vital functions of a driver 10, which can include a stress level or a fatigue value. In particular, this can be a respiration of the driver 10 or a heartbeat of the driver 10, which can be detected by way of a periodic movement of a chest of the driver 10. This can involve periodic movements that take place in predetermined frequency ranges with predetermined amplitudes. By way of example, this can allow the fatigue or health of the driver 10 to be monitored. There can also be provision for a further vehicle occupant 11 in the interior 5 to be detected by detecting heartbeats or respiratory movements. There can also be provision for the ultra-wideband device 1 to be configured to detect predetermined non-periodic movements 7 in order to activate predetermined actions in the vehicle 4. The predetermined non-periodic movements can be, for example, a gesture by a vehicle occupant 11 who wants to initiate the predetermined action by means of the gesture. There can also be provision for a break-in to be detected by detecting a non-periodic, predetermined movement 7 in the vehicle interior 5. The predetermined non-periodic movement in the surroundings 6 of the vehicle 4 can be, for example, a kick movement by a person 12 who is in a predetermined local area 13 in the surroundings 6 of the vehicle 4 and wants to open a trunk 14 of the vehicle 4 by means of the predetermined movement 7. In order to be able to detect the predetermined movements 7, there can be provision for the ultra-wideband sensors 2 to transmit impulse radio signals TX at specific times t and to receive a respective echo signal RX for each of the impulse radio signals TX. There can be provision for a respective one of the ultra-wideband sensors 2 to be provided both as a transmitter of the impulse radio signal TX and as a receiver for detecting the echo signal RX. There can also be provision for the impulse radio signal TX to be transmitted and the echo signal RX to be received by different ultra-wideband sensors 2.

It is possible to use the ultra-wideband sensors 2 in an active locating mode and in a passive mode to observe the surroundings. The additional passive mode and the different placement locations inside and outside of the vehicle 4 also allow this new type of technology and the new locating service to cover the mentioned services of driver/passenger observation and kick- or gesture-based opening. This great advantage permits the number of sensors in the vehicle 4 to be reduced and additional services to be provided.

The passive mode allows changes in amplitude, phase and spectrum between successive channel impulse responses h(τ) to be detected and a kind of motion profile to be produced. The fast Fourier transformation FFT and the known distance between the emitted impulse radio signals TX can be used to determine a speed and the distance of an object over the time t.

FIG. 2 shows a sequence of a method for operating an ultra-wideband device 1. The method can be carried out, for example, by the ultra-wideband device 1 shown in FIG. 1. To explain the individual steps of the method, reference is made to the other figures.

There can be provision for a first step P1 of the method to comprise an ultra-wideband sensor 2 of the ultra-wideband device 1 sending impulse radio signals TX at different times t and receiving the respective echo signals RX of the impulse radio signals TX. The ultra-wideband sensor 2 and/or the control device 3 of the ultra-wideband device 1 can use the echo signals RX to determine respective channel impulse responses h(τ) that describe an intensity of an echo signal RX over a path delay τ. The path delay τ can describe a time between the transmission of the impulse radio signal TX and a time at which the associated echo signal RX is received. Since a propagation speed of the signals TX and RX at the speed of light c is known, the path delay τ is proportional to a distance of an object that has reflected the impulse radio signal TX as the echo signal RX. It may be that the impulse radio signal TX is reflected from multiple objects, which may be at different respective distances from the ultra-wideband sensor 2. As a result, a multiplicity of intensity maxima can exist in a channel impulse response h(τ) for respective path delays T. As a result of multiple echo signals RX from impulse radio signals TX sent at different times t being received by the ultra-wideband sensor 2, respective channel impulse responses h(τ) can be detected for respective times t.

Knowledge of the times t at which a respective impulse radio signal TX was transmitted allows a time-variant channel impulse response h(t, τ) to be generated from the individual channel impulse responses h(τ). For larger movements, which can be detected by the resolving power of the ultra-wideband sensor 2, for example, it may be possible to identify that a respective maximum P associated with a respective object has a change in the path delay τP between individual channel impulse responses h(τ). One problem is now to provide a method step that makes it possible to detect this movement. This requires the time-variant components of the time-variant channel impulse response h(t, τ) to be examined. One way to detect the movements is to apply a transformation to the time-variant channel impulse response h(t, τ) in order to transform the time-variant channel impulse response h(τ, τ) from a time dependence on t to a dependence on the Doppler frequency v. This allows the scatter function hs(v, τ) of the time-variant channel impulse response h(τ, τ) to be obtained, in which movements with their respective Doppler frequency vP and their respective path delay τP appear as a local maximum P. The Doppler frequencies vP result from the fact that the frequency of the echo signal RX changes on the basis of whether an object is moving towards or away from the ultra-wideband sensor 2.

In order to prepare the evaluation of the scatter function hs(v, τ) and in particular to reduce DC components, there can be provision for a step P2 to comprise using a DC component filter in order to filter out a DC component. The DC component filter removes the mean component of the channel impulse response h(t, τ) with respect to the Doppler spectrum, i.e. the filter rejects the scatter function component at v=0 Hz. This filter can be, for example, a recursive filter whose transfer function is G, where z is the complex frequency variable and R is a real constant. Other filter characteristics can also be used.

$$G ( z ) = ( 1 - {z}^{∧} - 1 ) / ( 1 - {Rz}^{∧} - 1 )$$

In addition, other methods for rejecting static echo signals can also be used, for example based on a moving low-pass filter, the singular value decomposition of the channel matrix h(t, τ) or the subtraction of one or more preceding channel impulse responses (“range profile subtraction”).

However, producing the scatter function hs(v, τ) over an entire time period of a longer measurement may be unsuitable for being able to detect individual movements. It is therefore necessary to generate time-variant scatter functions hs(v, τ) for respective time windows in a step P3. For this purpose, predetermined lengths of the time windows and distances between the time windows are selected, from which a respective scatter function hs(v, τ) is generated. This computes the time-dependent Doppler spectra. This is done by applying a transformation that permits a frequency analysis. This can be, for example, a discrete cosine transformation, a Laplace transformation, a Walsh transformation, a Fourier transformation or a variant of the discrete Fourier transformation. This transformation is applied to a number of successive time-variant channel impulse responses h(t, τ). A set of successive channel impulse responses h(t, τ) is taken to compute the time-dependent Doppler spectrum hs(v, τ).

t0 is the sampling period, i.e. the time difference between successive channel impulse responses h(τ). The sets of time-variant channel impulse responses h(t, τ) can overlap when computing the Doppler spectrum, the time window between adjacent sets of channel impulse responses h(t, τ) being able to be defined as follows:
tm=m t0
where m≤n.

A first set of channel impulse responses h(t, τ) extends over t=0 . . . (n−1)t0,
a second set from t=m t0 . . . (m+n−1)t0,
a third set from t=(2m)t0 . . . (2m+n−1)t0
and so on.

For m=n, the next set of n channel impulse responses h(t, τ) is always selected without overlap. For m>n, (m−n) channel impulse responses between two sets are not considered for the computation, e.g. to prevent an undesirable periodic event from appearing in the Doppler spectrum.

Respective maxima P in the respective scatter functions hs(v, τ) may be identifiable, which may be associated with a moving object. If the object is an object that moves over a small area, meaning that the change of location cannot be detected by the ultra-wideband sensors 2, it may be the case, for example, that the respective maximum P occurs at different times t for identical path delays τP. However, the Doppler frequency vP can vary over the time t. If the movement is larger and takes place over a wider range of distance from one of the ultra-wideband sensors 2, the ascertained path delays τP of the maxima P can vary over the time t and thus between the time windows.

The problem is therefore that of detecting at least one local maximum P in step P4. The next section ascertains the Doppler frequency vP in each of the time-variant scatter functions hs(v, τ), which shows the maximum absolute value of the scatter function hs(v, τ) over all path delays τP or taps T/TO, where TO is the sampling period of the path delay τ. After that, the path delay τ can be selected as the ascertained path delay τP that maximizes the respective time-variant scatter function hs(v, τ). In other words, a 2D maximum search is applied to each of the time-variant scatter functions hs(v, τ) obtained in the previous step P4 in order to select local maxima P having a respective Doppler frequency vP and a respective path delay τP.

A further variant for ascertaining the ascertained path delay τP corresponding to the movement to be detected uses the local maxima P of the time-variant scatter functions hs(v, τ). Instead of using the global maximum as a criterion, Doppler shifts v are observed over the different time-variant scatter functions hs(v, τ) in order to determine the nature of the movement. In the case of a periodic movement, for example, a periodic change in the Doppler shifts vP can be observed for the applicable path delay τP. Thus, the path delay τP can be ascertained based on the movement to be expected using the time characteristic of the Doppler shift vP.

In a subsequent method step P5, it may be necessary to select the at least one ascertained path delay τP for which a signal characteristic φ(t) is meant to be determined. In the case of a movement taking place over a narrow range of distance from the ultra-wideband sensor 2, it may be possible for only one ascertained path delay τP to be selected, because the movement takes place only in this range of distance. If multiple movements take place or if a movement comprises multiple Doppler frequencies vP, it may be that several of the maxima P are selected.

In the event of larger movements occurring and the moving object being at different distances from the ultra-wideband sensor 2, it may be necessary to select different ascertained path delays τP for the maximum P for the individual time windows. This requires the change in position of the maximum P to be tracked over several of the scatter functions hs(v, τ). Method step P5 thus requires at least one respective ascertained path delay τP of the local maximum P to be determined in order to track a respective local maximum P. The at least one path delay τP that is meant to be taken into account for the motion detection can be selected in this case. This can be done by selecting the most frequently ascertained path delay τP for the respective local maximum P or by selecting all path delays τP ascertained for the respective maximum P or by way of another selection method.

In order to be able to evaluate the detected movement and to be able to detect the predetermined movements 7, a signal characteristic φ(t) is determined for the at least one detected maximum P. In other words, the time-variant channel impulse response h(t, τ) is transformed in order to obtain the signal characteristic φ(t) for the at least one maximum P over the time t. If the movement has a constant path delay τP, it is sufficient to transform the time-variant channel impulse response h(t, τ) for a single path delay τP into a signal characteristic φ(t). If the maximum P moves over a wider range of distance from the ultra-wideband sensor 2, multiple different ascertained path delays τP need to be taken into account to examine the movement. In this case, the signal characteristic φ(t) for each of the ascertained path delays τP can be generated from the time-variable channel impulse response h(t, τ). In a second step, a single signal characteristic φ(t) can be composed from individual sections of the signal characteristics φ(t). For the composite signal characteristic φ(t), the respective period of time in the signal characteristic φ(t) that is associated with the respective ascertained path delay τP for which the movement occurs is selected. If, for example, the movement occurs in a first half of a time period for the ascertained path delay τP with the index P=5 and in a second half of the time period for the ascertained path delay τP with the index P=6, the composite signal characteristic ϕ(t) is composed from the signal characteristic ϕ(t) for P=5 in the first half and the signal characteristic ϕ(t) for P=6 in the second half. The evaluation of the signal characteristic φ(t) is necessary because, due to the low spatial resolution already mentioned for small movements, a movement evaluation based on a change of location is not possible. However, use is made of the fact that a movement over a time period results in the phase angle in the individual channel impulse responses h(τ) changing over the time t, for example. It is thus possible, for example by evaluating the phase, frequency or amplitude in the signal characteristic φ(t), to detect and evaluate movements even if this were not possible due to the insufficient spatial resolution of the ultra-wideband sensors 2. The at least one selected maximum P is taken as a basis for computing the argument of the channel impulse response h(t, τ) over the time t for τP=P τ0. A low-pass filter can be applied before the computation to remove rapid changes over the time t caused by random signals (e.g. noise) or impairments.

In a next step P7, there can be provision to use a decimator in order to reduce the sampling rate of the signal characteristic φ(t) with respect to t. The decimator reduces the sampling rate with respect to t. It allows the data rate to be reduced so long as the sampling rate permits the Doppler frequency shift to be detected.

A step P8 comprises detecting predetermined frequency movements. A case distinction may be necessary here, depending on whether a periodic or a non-periodic movement is meant to be detected. If a periodic movement is meant to be detected, the signal characteristic φ(t) can be transformed to the frequency domain. This allows the individual frequency components of the signal characteristic ϕ(t) to be detected. In order to detect a predetermined period, there can be provision for the frequency spectrum to be examined for the presence of a maximum. There can also be provision for a threshold value to be predefined for one or more frequencies associated with a movement. There can be provision for the frequency to relate to a respiration or a heartbeat. There can be provision for a heartbeat to be detected when the predetermined frequency exceeds a predetermined amplitude.

If a non-periodic movement is meant to be detected as the predetermined movement, there can be provision for a predetermined pattern to be predefined, which is compared with the signal characteristic φ(t). It may be that the pattern describes a predetermined response of the phase and this predetermined response is compared with the recorded response by means of a similarity function. If the similarity exceeds a predetermined threshold value or if it meets another predetermined similarity criterion, the predetermined movement can be detected. A frequency detector can detect the frequency of the signal characteristic φ(t). This implies a periodic signal, the period of which can be estimated e.g. by looking for the dominant frequency in the applicable frequency response. For a non-periodic signal, as caused by a one-off movement such as a kick or a gesture, a signal detector can be used that e.g. returns the probability that the signal is caused by the predetermined movement.

FIG. 3 shows a possible signal characteristic φ(t) over the time t and the path delay τ. The signal characteristics are shown over a time t for specific path delays τP. Since the path delays τP are proportional to the distances of the movement from the sensor, a respective line shows how the phase changes over a time t for a predetermined distance. Three of the characteristics describe the time characteristic for path delays τP of 14 τ0, 15 τ0 and 16 τ0. A dominant oscillation having a frequency of approximately 0.33 Hz can be seen in these. This is a respiratory rate of a chest at a distance of 14-16 TO. The variation in the phase angle results from the changing propagation time between the transmitted and received signals over the time t.

FIG. 4 shows a characteristic for the phases of the three path delays 14 τ0, 15 τ0 and 16 τ0 over the time t.

FIG. 5 shows an exemplary scatter function hs(v, τ) obtained for a periodic movement, which is a respiratory movement. The scatter function is based on an evaluation of 1276 successively recorded channel impulse responses h(τ). A Doppler shift with a maximum P can be seen in one area. The path delay τP of the maximum P shows the distance between the ultra-wideband sensor 2 and the object that causes the time variations in the channel impulse response h(t, τ). In this case, said respiratory movement of a human body is involved. The scatter function hs(v, τ) was normalized with respect to its maximum for the 1276 successive channel impulse responses. The individual channel impulse responses h(τ) were recorded with an interval of time for t of 8 ms. The resolution of the Doppler frequency v is approximately 0.1 Hz. The maximum P, which can be seen at around 9 ns, is due to internal reflections in the ultra-wideband sensor 2 and cannot be associated with any movement. Considering the scatter function hs(v, τ) for all channel impulse responses h(τ) in one fell swoop shows a continuous Doppler spectrum, since respiration or a similar movement comprises specific phases of acceleration, deceleration and rest. In order to resolve a specific movement, the scatter function hs(v, τ) is required for respective periods of time.

FIG. 6 shows a characteristic for the time-variant scatter function hs(v, τ) as a function of the time t. The individual scatter functions hs(v, τ) were normalized with respect to their respective maximum P. Each spectrum comprises 150 successive channel impulse responses h(t, τ). This is the dataset that was also used in the previous FIG. 5. It can be observed in FIG. 6 that the Doppler frequency vP of the maximum P of the scatter function hs(v, τ) changes over the time t. In this case, the variation corresponds to a person's respiratory movement in a range that follows a specific path delay τ. This specific path delay τP can be ascertained using the time-variable scatter function hs(v, τ). This is accomplished by looking for the Doppler frequency vP and the path delay τP of the maximum P of the time-variant scatter functions hs(v, τ). Ideally, each of the scatter functions hs(v, τ) shows its maximum P for the same path delay τP. In a real scenario, multiple path delays τP can arise. In this case, for example the path delay τP that appears most frequently is selected for the further evaluation. This is particularly advantageous when the movement is small. As an alternative to this, all path delays τP for which the maximum P occurred can be taken into account for the further procedure. This is particularly advantageous in the case of larger movements that extend over at least two ranges of resolution.

FIGS. 7a and 7b show the method step for selecting the path delays τP that have a maximum amplitude in the Doppler frequency vP. The individual dots show complex values of the time-discrete, time-variant channel impulse response h(t, τ); each row represents a change over the time t for a specific path delay τP. Each column represents a channel impulse response h(τ) at a specific time. For movements over a small range of distance, as seen in FIG. 7a, the path delay τP of a maximum determined using the time-variant scatter functions hs(v, τ) is almost constant. As a result, one path delay τP appears more frequently than others. In this case, the path delay τP that occurs most frequently is selected. This means that a single row of the time-discrete channel impulse response h(t, τ) is selected, as shown in the top illustration.

For larger-scale movements, as seen in FIG. 7b, the path delay τP for which the maximum Doppler amplitude occurs varies over the time t. This is due to the fact that the reflection by an object is detected earlier or later depending on the distance. In this case, multiple path delays τP are taken into account for all channel impulse responses h(t, τ), as a result of which an area-by-area selection for individual periods of time is made, as shown in the bottom illustration.

FIG. 8 shows the histogram of the path delays τP of the maximum Doppler spectrum obtained from the time-variant scatter functions in FIG. 7. The path delay τP is indicated with respect to the sampling period T/TO and represents the sampling index P, because the channel impulse responses are indicated in discrete time. As can be seen, the maximum appears for a path delay τP=P τ0 with the sampling index P and the sampling period TO. If the maximum is known, the change in the argument of h(t, τ) over time can be selected for T=P τ0, which allows assessment of whether the change over time is caused by a specific movement.

FIG. 9 shows the signal characteristic φ(t) of the phase over the time t for the path delay τP, P=15. A periodic signal with regularly recurring maxima and minima can be seen. In order to obtain the frequency components that the signal characteristic φ(t) shown in FIG. 9 has, the frequency spectrum of the signal characteristic φ(t) can be evaluated. This can be computed by way of a Fourier transformation with respect to the time t. The green curve shows the phase for the original data. The curve ϕf(t) was obtained by applying a 20th-order digital low-pass filter in the Doppler frequency range with a maximum passband frequency of 6 Hz and a stop-band frequency of 10 Hz. The characteristic ϕu(t) is unfiltered.

FIG. 10: frequency response of the argument of the channel impulse response for the path delay τP, P=15. The curve c1 shows the absolute value obtained for the original data. The curve c2 was obtained by applying a 20th-order digital low-pass filter in the Doppler frequency range with a maximum passband frequency of 6 Hz and a stop-band frequency of 10 Hz to the channel impulse response for the path delay τP, P=15. For the curve c3, in addition to the Doppler low-pass filter, a DC block was applied to the phase variation shown in FIG. 9. As can be seen, when applying a Doppler low-pass filter and possibly additionally a DC component filter, the strongest spectral component appears at approximately 0.39 Hz, which is characteristic of human respiration.

FIG. 11 shows the scatter function for a time-variant channel impulse response of a non-periodic movement. The approach discussed can also be applied to the detection of non-periodic movements, such as e.g. a kick. FIG. 11 shows the scatter function hs(v, τ) for a time-variant channel impulse response h(t, τ) obtained from the measurement of a signal reflection caused by a kick. In contrast to the channel impulse response for a respiration (see FIG. 5), the Doppler shifts are not confined to a specific path delay τP, but appear for multiple path delays τP, indicating that the magnitude of the movement exceeds the area resolution that follows from the path delay resolution. Absolute value of an illustrative scatter function h, normalized to its maximum P, for 505 successive channel impulse responses h(t, τ) measured every 4 ms. What is shown is the magnified response obtained from the measurement of the reflection caused by a kick.

This conclusion can also be drawn from the time-resolved Doppler spectra shown in FIG. 12. As observed, the Doppler shifts vary significantly over the time t, yet there are a number of samples for which the maxima occur. The time-variant magnitude of the scatter function hs(v, τ) is shown, normalized to its respective maximum P. Each spectrum hs(v, τ) consists of 50 successive channel impulse responses h(τ) that have been obtained from the measurement of the reflection caused by a kick.

The histogram in FIG. 13 clearly shows that no tap stands out. That is to say that, instead of selecting a single row in the matrix representing the time-discrete time-variant channel impulse response h(t, τ), sections from multiple rows are selected, as shown in FIG. 14. The taps considered can be shown by a set P with J the number of Doppler spectra computed. Each P represents the number of the tap showing the maximum magnitude for the jth Doppler spectrum. A histogram of the path delays τP with maximum Doppler spectra for the scatter functions h(s, τ) shown in FIG. 13. This is an illustration of which parts of the time-discrete time-variable channel impulse response h(t, τ) are selected according to the taps in FIG. 13.

FIG. 15 shows the phase change over the time t. The movement is distinct and can be identified by a suitable signal detector.

What is shown is a time characteristic for the argument of the section-by-section channel impulse responses for P from FIG. 14. The curve shows the signal characteristic ϕu(t) obtained from the raw data of the measurement. The curve ϕf(t) was obtained by applying a 20th-order digital low-pass filter in the Doppler frequency range with a maximum passband frequency of 30 Hz and a stop-band frequency of 40 Hz.

FIG. 16 shows a motion profile for a detected person; the speed and location can be determined from successive channel impulse responses by using the fast Fourier transformation (FFT).

FIG. 17 shows a distance profile for a moving person over the time t, ascertained by means of the fast Fourier transformation (FFT) from successive channel impulse responses and the intervals of time between the channel impulse responses.

The method according to the invention can be used to detect a predetermined movement. The predetermined movement can be a respiratory movement, for example. The method can also be used for gesture recognition, for example to recognize a hand gesture as the predetermined movement for switching the windshield wipers on and off. A further possibility for application is kick detection in order for this to initiate opening of the trunk 14 of a vehicle 4. The method is also suitable for theft detection, which can be used in a vehicle 4, a room or a building. In general, the detection of an event that is variable over time, for example in order to trigger a predetermined action, is made possible by the invention.

Detection of a movement is possible so long as the sampling rate to between successive channel impulse responses h(τ) is low enough to detect the Doppler frequency shift caused by the movement. Mathematically speaking, if the maximum Doppler shift is given by v, then according to the sampling theorem: 1/t0≥2v.

Overall, the example shows how the invention can provide a method for determining the distance of a movement.

### LIST OF REFERENCE SIGNS

1 ultra-wideband device
2 ultra-wideband sensor
3 control unit
4 vehicle
5 vehicle interior
6 surroundings
7 predetermined movement
8 control signal
9 interface
10 driver
11 vehicle occupant
12 person
13 predetermined detection area
14 trunk
TX impulse radio signal
RX echo signal ϕ0(t) comparison signal characteristic ϕ(t) signal characteristic
ϕu(t) unfiltered signal characteristic
ϕf(t) filtered signal characteristic
P local maximum
T path delay
TP ascertained path delay
V Doppler frequency
vP ascertained Doppler frequency
dc threshold of the similarity value
d(t) similarity value
h(τ) channel impulse response
h(t, τ) time-variant channel impulse response
hs(v, τ) scatter function
t time

1. A method for operating an ultra-wideband device comprising:
at an ultra-wideband sensor:
transmitting impulse radio signals at different times and generating respective channel impulse responses that describe a respective reflected signal as a function of a path delay,
using the channel impulse responses to generate a time-variant channel impulse response in which the channel impulse responses are arranged according to times of transmission of respective associated impulse radio signals,
transforming predetermined time windows of the time-variant channel impulse response to produce respective scatter functions of the Doppler frequency,
detecting in the scatter functions of the respective time windows at least one respective local maximum of a scatter function quantity, characterized by a respective Doppler frequency and a respective path delay,
using a predetermined selection method to select at least one local maximum as a respective observation maximum to be tracked for motion detection,
generating a signal characteristic of the channel impulse response for the respective observation maximum to be tracked, and
detecting using a predetermined motion detection method at least one predetermined movement of the observation maximum to be tracked in the signal characteristic of the channel impulse response.

2. The method as claimed in claim 1, wherein a periodic movement is detected as the predetermined movement (7) by the predetermined motion detection method.

3. The method as claimed in claim 1, wherein a non-periodic movement is detected as the predetermined movement by the predetermined motion detection method.

4. The method as claimed in claim 1, wherein the channel impulse responses are filtered by a DC component filter.

5. The method as claimed in claim 1, wherein a low-pass filter is applied to Doppler frequency domain.

6. The method as claimed in claim 1, wherein the detecting of the predetermined movement results in a control signal being provided on an interface of the ultra-wideband device.

7. The method as claimed in claim 1, wherein a low-pass filter is applied to a frequency domain of the signal characteristic ϕ(t).

8. The method as claimed in claim 1, wherein before the motion detection method is carried out, a temporal sampling rate of the signal characteristic is reduced by a decimator.

9. An ultra-wideband device configured to:
transmit impulse radio signals at different times by way of an ultra-wideband sensor and to generate respective channel impulse responses that describe a respective reflected signal as a function of a path delay,
use the channel impulse responses to generate a time-variant channel impulse response in which the channel impulse responses are arranged according to the times of transmission of respective associated impulse radio signals,
transform predetermined time windows of the time-variant channel impulse response to produce respective scatter functions of a Doppler frequency,
detect at least one respective local maximum of scatter function quantity, characterized by a respective Doppler frequency and a respective path delay, in the scatter functions of the respective time windows,
use a predetermined selection method to select at least one local maximum as a respective observation maximum to be tracked for motion detection,
generate a signal characteristic of the channel impulse response for the respective observation maximum to be tracked, and
use a predetermined motion detection method to detect at least one predetermined movement of the observation maximum to be tracked in the signal characteristic of the channel impulse response.

10. A vehicle comprising an ultra-wideband device as claimed in claim 9.
